(19) United States
(12) Patent Application Publication
(10) Pub. No.: US 2003/0107861 A1
(43) Pub. Date: Jun. 12, 2003

(54) Method and apparatus for disconnecting a battery

(76) Inventor: Lawrence Dean Hazelton, Goodrich, MI (US)

Correspondence Address: MARGARET A. DOBROWITSKY, DELPHI TECHNOLOGIES, INC., P.O. Box 5052, Mail Code: 480-414-420, Troy, MI, 48007-5052, US

(21) Appl. No.: 10/010,136

(22) Filed: Dec. 6, 2001

(51) Int. Cl. H02H 3/24

(52) U.S. Cl. 361/92

(57) ABSTRACT

A battery protection system for a battery having a switching mechanism positioned intermediate to the positive terminal and an electrical load of the battery. A controller manipulates the switching mechanism between an open position and a closed position, the closed position connects the electrical load to the battery and the open position disconnects the electrical load from the battery. The battery protection system utilizes a battery status detection system, which instructs the controller to open the switching mechanism when the detection system detects a signal from an accelerometer, the signal from the accelerometer corresponding to a vehicle crash.

### CROSS REFERENCE TO RELATED APPLICATIONS

This application is related to commonly owned and assigned U.S. patent application Ser. Nos. 09/667,095, 09/667,332 and 09/666,581 each being filed on Sep. 21, 2000 respectively, the contents of which are incorporated herein by reference thereto.

### TECHNICAL FIELD

The present invention relates to vehicle batteries. In particular, the present invention provides a method and apparatus for disconnecting the battery in event of a crash.

### BACKGROUND OF THE INVENTION

Motor vehicles, such as cars, marine vessels, trucks and the like almost universally include a battery that is used for engine ignition. The battery is also electrically connected to other electrical loads in the vehicle, such as hazard lights, radios, running lights, etc. If the vehicle is involved in an accident or severe collision it is desirable to disconnect the battery from the electrical system.

### SUMMARY OF THE INVENTION

A method and apparatus for determining whether a vehicle has been involved in a crash. The apparatus disconnects a battery of the vehicle from any electrical loads.

A battery provided with a detection and switching mechanism. The detection and switching mechanism determines whether the battery and or the vehicle it is associated with has been involved in an accident. If so, the switching mechanism disconnects the battery from any electrical loads.

A battery detection and switching mechanism wherein the detection and switching mechanism is integral with the battery and determines whether the battery and/or the vehicle it is associated with has been involved in an accident. If so, the switching mechanism prohibits the battery from supplying any current.

The above-described and other features and advantages of the present invention will be appreciated and understood by those skilled in the art from the following detailed description, drawings, and appended claims.

### BRIEF DESCRIPTION OF THE DRAWINGS

FIG. 1 illustrates a block diagram of an exemplary embodiment of the invention;

FIG. 2 illustrates an exemplary embodiment of a simplified battery disconnect system; and

FIG. 3 is a flowchart illustrating portions of a command sequence employed by a control algorithm utilized in an exemplary embodiment of the present invention.

### DESCRIPTION OF THE PREFERRED EMBODIMENT

The purpose of the battery protection system is to disconnect the battery from the vehicle's electrical system in the event of a crash or collision. The battery disconnect system only requires electrical connections at the battery terminals. No other electrical connections are required.

An accelerometer provides a signal to a microprocessor that will respond by commanding a FET array to turn off. The accelerometer is positioned to provide an input to the microprocessor instructing the battery to be disconnected from its electrical loads. The microprocessor software will inhibit a reconnection from occurring after a crash has occurred. One possible way to turn the FET array back on in this case is to turn the battery protection system off and then back on with the manual on/off switch.

The FET gate control operates when the software determines that the FET array should be turned on (battery connected) or off (battery disconnected). The microprocessor commands a circuit that drives the gates of the FET array either pulling them high or pulling them to ground.

The manual switch and/or switch override is mounted on the case of the physical embodiment of battery protection system is used to power-up/down the battery protection system. All loads presented to the battery are removed when the switch is in the off position, except for the FET array leakage current. The switch off position would be selected when the car is to be in long-term storage, because it virtually eliminates the vehicle parasitic load from the battery, which can be 20 mA or more with the vehicle parked. Vehicle parasitic load can disable cranking ability in as little as two months.

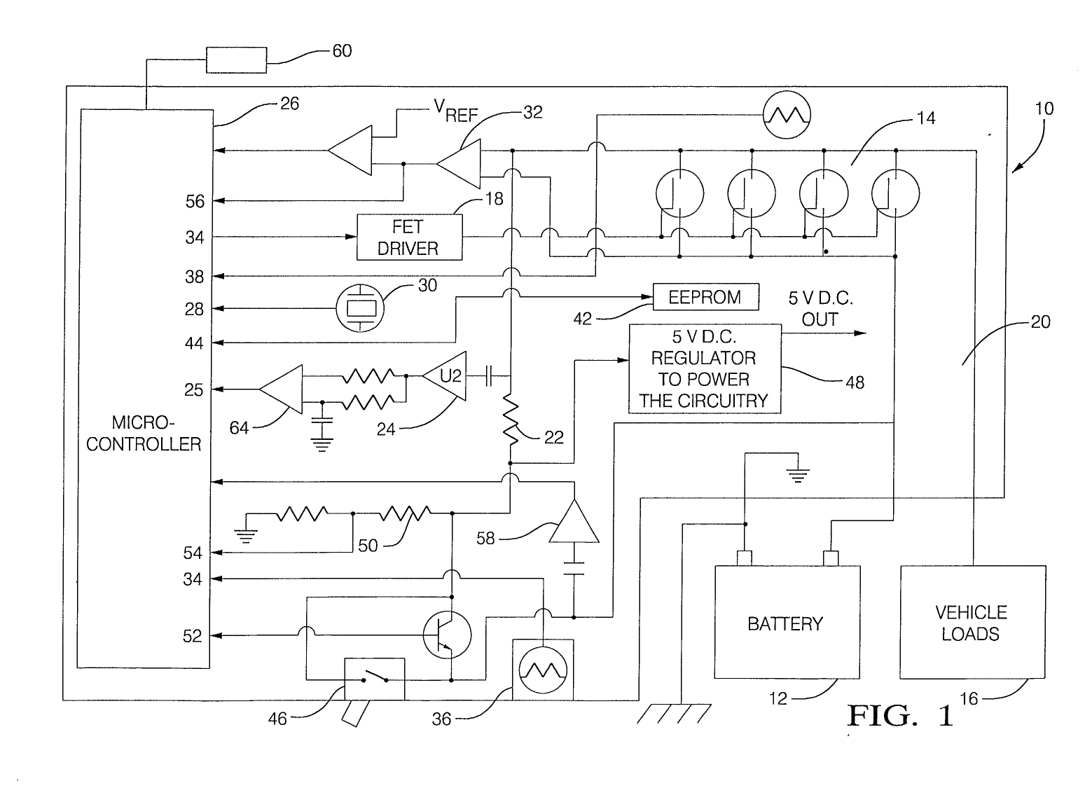

FIG. 1 is an exemplary embodiment of a complete battery protection system 10. A basic element of the battery protection system is the use of one or more electronic switches (FETs) in parallel that open and disconnect the vehicle electrical load under certain commands from the battery protection system. The advantage of an electronic switch over electrically controlled mechanical switches is freedom of arcing under high current conditions. Mechanical switches are also subject to contamination from environmental conditions that exist within a vehicle engine area.

FIG. 1 illustrates an exemplary embodiment of battery protection system 10. The positive terminal of a battery 12 is connected to an input of a circuit board (not shown) of battery protection system 10. In addition, the positive terminal of battery 12 is also connected to the drain connections of a FET array 14. FET array 14 consists of a plurality of electronic switches (FETs) or gates. There are four such FETs in the exemplary embodiment since a single FET is not capable of handling the current load. However, and depending upon the current load or anticipated current load, fewer or more FETs may be used in array 14. Moreover, and if a single FET is capable of carrying the anticipated current load, a single FET can be used.

The sources of the FETs are connected to a vehicle load 16. In addition, the gates of array 14 are coupled to the output of a gate drive circuit or FET driver 18. Vehicle load 16 is also connected to a load sense input 20 of the battery protection system. The battery protection system only requires three connections to the automobile wiring. This permits the battery protection system to be mounted onto the terminals of a battery with the positive connector of the load being connected to the output of the battery protection system. The output is electrically at the junction of the source terminals of the FETs and the junction noted as 20 in FIG. 1.

Fundamentally, the system provides a switch between the positive terminal of the battery and the load. The FET gate signals are such that for a given battery and load condition, the FETs are opened thus disconnecting the battery. It is important to note that resistor 22 is in parallel with the FET source and drain connections such that when the FETs create an open condition, a small amount of current less than 2 milli-amperes flows from the battery through the load. An exemplary value of the resistor is 6 Kohms. When the FETs are open, a change on the load will appear as a voltage change on the load sense input 20. An amplifier 24 provides the voltage change to an interrupt input of a microprocessor 26.

An exemplary microprocessor is the 16C73 microprocessor made by Microchip Corporation. Of course, other similar microprocessors are contemplated for use in the battery disconnect system.

The battery protection system has an ON/OFF switch 46 and a switch override transistor 40 in conjunction with microprocessor 26. When switch 46 is closed, the battery voltage is connected to a 5 volt regulator 48 that provides power to the circuitry of the system. In addition, it provides the battery voltage to a voltage divider 50 that is coupled to a VBAT input of the microprocessor, which converts the DC voltage to a digital signal representative of the battery voltage. An output 52 of microprocessor 26 provides a switch override function.

With the availability of large-scale integration it is likely that most of the circuitry involved with the battery protection system may be included within a single integrated circuit. The system may include one circuit board housing the control circuitry and a separate circuit board holding the FET switches. The entire unit may be packaged so that it can be mounted on the battery itself.

An accelerometer 60 provides in input to microcontroller 26 indicating that the vehicle is experiencing a collision or crash. Accelerometer 60 is similar to accelerometers used to provide signals to deploy safety restraint systems such as air bags.

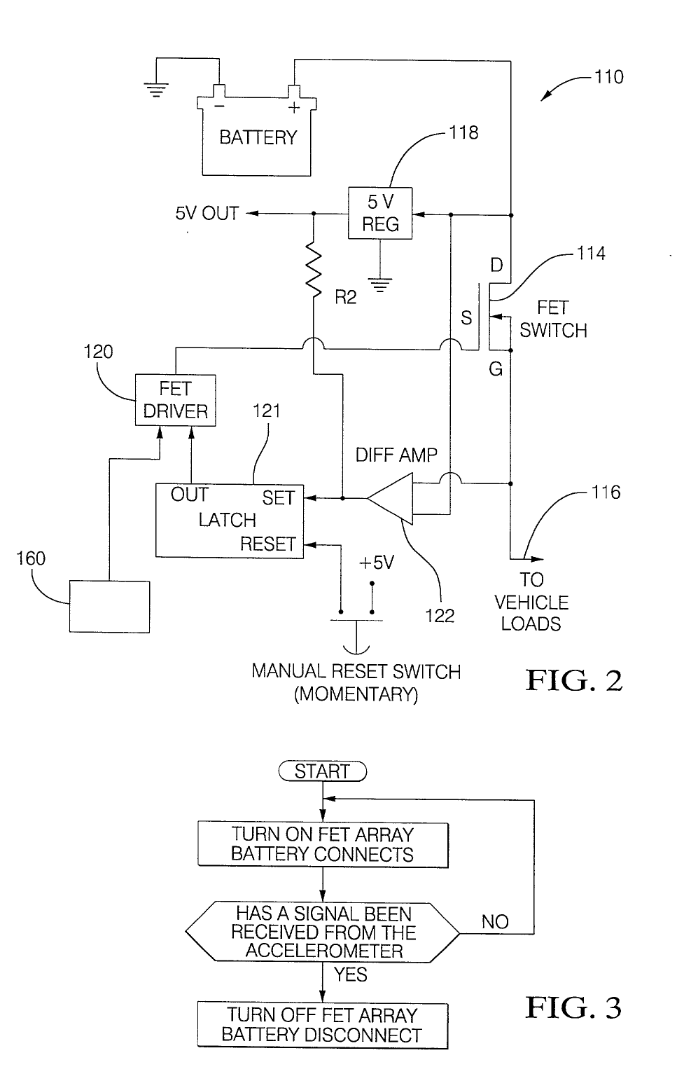

A simplified embodiment of the circuitry illustrated in FIG. 1 is shown in FIG. 2 as 110. This limited circuitry illustrates an embodiment that is limited to prevention of the deleterious effects from short circuits within the vehicle load 116 which may be caused by a vehicle crash. In this embodiment, the circuitry is limited to the FET switches of array 114, a regulated power supply 118, a High Current detector Differential Amplifier 122, a Latching Integrated Circuit 121, and a FET Gate Drive Circuit 120.

An accelerometer 160 provides a signal to the FET driver instructing the FET array to open in event of a collision. The input will the gate drive circuit 120 to apply “ground” to the gates of the FET switches of array 114. This will cause the FET switches of array 114 to open, disconnecting the battery from the load.

There is no requirement for an additional wire to be connected from the ignition key switch and/or the hazard switch to the smart battery electronics. This is particularly advantageous in aftermarket applications wherein access to the automobile electronics is very limited. In addition, this method also allows the detection system to be installed with a reduced labor and component cost as opposed to other signal sensing devices.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A battery discharge protection system, comprising:
a) a microprocessor being capable of receiving a plurality of inputs, said inputs corresponding to signals from a vehicle;
b) a plurality of electronic switches being configured for movement between an open position and a closed position, said closed position connecting an electrical load to said battery, said open position disconnecting said electrical load from said battery; and
c) a gate input circuit for manipulating said switches between said open and closed positions in response to an output received from an accelerometer.

2. A battery protection system for a battery, comprising:
a) a switching mechanism positioned intermediate to the positive terminal of a battery and an electrical load;
b) a controller for manipulating said switching mechanism between an open position and a closed position, said closed position connecting said electrical load to said battery and said open position disconnecting said electrical load from said battery; and
c) a battery state detection system, said battery state-of-charge protection system instructs said controller to open said switching mechanism when said battery state corresponds to a vehicle crash.

3. A battery protection system as in claim 2, further comprising:
d) a vehicle status detection system, said vehicle status detection system instructs said controller to open said switching mechanism when a vehicle crash condition is detected by said vehicle status detection system.

4. A battery protection system as in claim 2, further comprising:
d) a manual override switch for disconnecting said battery from said electrical load.

5. A battery protection system as in claim 2, further comprising:
d) a vehicle status detection system, said vehicle status detection system instructs said controller to close said switching mechanism when a battery re-connect condition is detected by said vehicle status detection system.

6. A device for disconnecting a battery from an electrical load, comprising:
an electronic switch interposed between a battery output terminal and any battery electrical load;
a means for determining whether a vehicle in which said battery is installed is in a collision; and
a means for causing said electronic switch to transition from a closed-circuit condition to an open-circuit condition.

7. A method for disconnecting a vehicle battery when said vehicle is involved in a collision, comprising:
sensing a collision by a sensing device, said sensing device providing a signal to a control device;
commanding a control device to disconnect said battery from any electrical load.

8. The method as in claim 7, wherein said control device is a switching mechanism positioned intermediate to the positive terminal of a battery and any electrical load, said switching mechanism being operated by a controller for manipulating said switching mechanism between an open position and a closed position, said closed position connecting said electrical load to said battery and said open position disconnecting said electrical load from said battery.
